(19) United States
(12) Patent Application Publication
(10) Pub. No.: US 2017/0245518 A1
(43) Pub. Date: Aug. 31, 2017

(54) Assembly of chocolate coated edible material depicting floras replicas

(71) Applicant: Scott Martin Morris, Sylmar, CA (US)

(72) Inventor: Scott Martin Morris, Sylmar, CA (US)

(21) Appl. No.: 15/056,555

(22) Filed: Feb. 29, 2016

(51) Int. Cl. A23G 1/54; A23G 1/50

(52) U.S. Cl. CPC A23G 1/54; A23G 1/507; A23V 2002/00

(57) ABSTRACT

The utility model relates to assembly of flora(s) replica(s) (FIG. 16) comprised of theobroma cacao chocolate either un-sweet or sweetened or seasoned and or any combination and variety of theobroma cacao chocolate. Along with combining edible materials of same or different textures and flavors conjoined and or coated in some way with theobroma cacao chocolate. Once constructed into the flora replica invention lends itself to a wider array of cultures, tastes, social applications and dietary un-segregation. Resulting in overcoming the lack of flavor, economic negativity, and dietary segregation of prior art.

### CROSS-REFERENCE TO RELATED APPLICATION

Provisional Patent Application No. 62/143,034

No research funding

No Federal research funding

No sequence listing

### BACKGROUND

Edible flora replicas currently are comprised of single or double edible material that are either poured in to a mold or rolled out and cut to shape with special tools, special icing formulas in various colors and textures, edible modeling clay, confectionary dipped fruit and or hard candy sugar solutions. Either edible material or process of production the consumer is dietary segregated, limited in flavors and textures also the current floral replicas are economically wasteful plus dangerous. Many times the aforementioned are placed on other edible materials to enhance eye appeal also floras from edible material wrapped in inedible material to give the impression of a flower not intended to be eaten by the consumer wasting money. In either case the aforementioned is not economical, is limited in flavor or variety of edible material combinations and excludes dietary restricted consumers or pose a danger.

The inventor:“ [symbol] ”. #CN201726814 U, Feb. 2, 2011

Chocolate with Shape of Flower

CN 20172681411

Chocolate with shape of flower is a “DIY—Do it your self”

Mixing inedible matter with edible matter and leaving it up to the consumer to produce the flower.

This invention leaves the consumer stranded if something goes wrong. Perhaps the consumer is unaware of the techniques to handle chocolate, knowledge of tempering chocolate, void of a safe environment to “Do it yourself”. Chocolates called coating or compound chocolates are of low quality and can hardly be called chocolate. Thus the end result is a negative impact on the consumer with low quality product.

The inventor: “Kenji Yanagisawa” publication # EP0465884 A1 dated Jan. 15, 1992.

### Confection and its Production

EP 0465884 A1.

This withdrawn invention uses pre-formed shapes comprised of one single source material in order to produce edible replicas.

This invention is layers of single source material molded and piled on top of each other consisting of “confections” and “ROSE” shapes. Thus the consumer is lead to believe only confections can be made in to replicas. Non-confection edible material has the same characteristics for producing edible replicas.

The inventor: “Otto Schafer Leonhard” publication # U.S. Pat. No. 2,803,202 A, Aug. 21, 1957,

### Method and Apparatus for Forming Ornamental Objects

U.S. Pat. No. 2,803,202 A

This invention uses sugar candy and molds to form the replicas made of a single source material. The single source material is shaped and attached then layered upon each other to form the replica shapes.

The scope of this invention was to overcome the candy tendency to absorb moister in the ambient air. The super hot sugar candy is poured into die mold and after cooling the peaces are assembled and then attached. The process of production solves an issue at manufacturing. But, the single minded approach to have consumer(s) tethered to a single flavor/material profile limits the scope of the edible replica artistic value.

The inventor: “Shari L. Cone” publication # U.S. Pat. No. 5,229,149 A, date Jul. 20, 1993.

### Strawberry Simulating a Rose Bud

U.S. Pat. No. 5,329,149 A

Highly seasonal and perishable material coated and skewered. The seasonal invention placed on a hazardous pointed skewer placing the customer in harms way. The moister content of a well ripened fruit is a potential hazard. If the fruited rose is miss handled and the water content within the fruit leaches out. The outcome is destroyed presentation. The consumer is time limited to consume this invention and plus have to handle with extreme care guarding against over ripening and breakage and a sharp pointed skewer.

### CONCLUSION

The aforementioned inventions give focus to edible replicas that are limited and are pointed to a select few, raising the question as to why exclude the dietary restricted consumer. From “do it your self” to highly perishable materials to super heated sugar candy. All the flora replicas presented were of un-dynamic single or double source material more focused on the commercial aspect of the flora then the consumer need for a quality product and safety.

### SUMMARY

Currently edible flora replicas are constructed with single or double source edible material of witch is dietary segregating, of low quality or highly perishable plus dangerous, leaving the consumer negatively impacted.

Where by the use of mixed textured edible material comprised of savory and or confection assembled and coated with theobroma cacao chocolate in liquid state or dehydrated seasoned or spiced and or any combination of the aforementioned lends itself to enhancing flora replicas. This invention in all its combinations and varieties incorporates the dietary restricted allowing all consumers to enjoy the edible flora replica.

Further the flora replica invention can be colored to encompass a flora replica theme where by amassing a bouquet of flora replicas of witch all customers can enjoy with out dietary segregation and still be comprised of a mixture of edible material sweet and unsweetened.

### OBJECTIVE OF INVENTION

To enhance and exploit a variety of flavors, textures, edible material, sizes and or un-sweetened or sweet or savory and or any combination there of all mixed together to create a flora replica that is beautiful lending itself to a wider array of event applications and dietary requirements.

### Operation

Normal use of the invention once arranged can be colored to center around a theme flora. The size and color of the flora and or un-sweetened or sweet or savory floras are only limited by the ability for the assemble pieces to maintain structural integrity and labor investment. The floras can be placed on plates, serving platter or even stems for a bouquet presentation. Grouping of the floras replica's of contrasting flavors and texture and or colors and or sweetened or un-sweetened and or spiced and or seasoned build a variety of pleasing to the eye replicas such as used in a flora bouquet all with out dietary segregation of any and all consumers.

### DETAILED DESCRIPTION

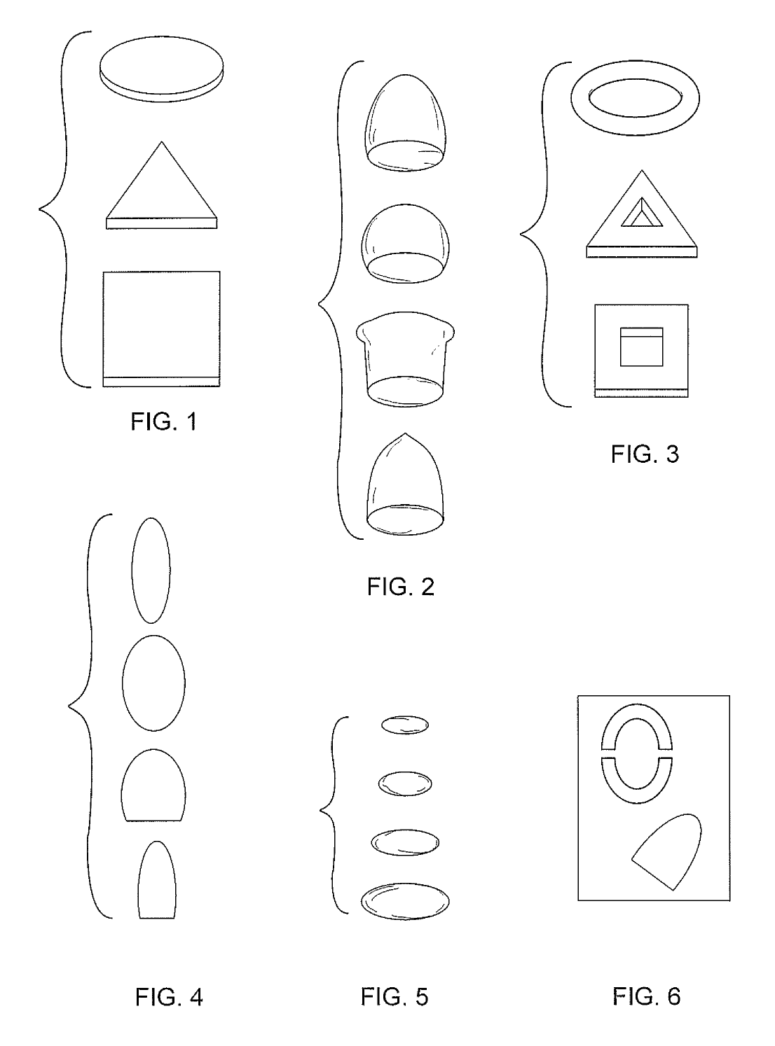

Assembly of chocolate coated edible material depicting flora(s) replica(s) consisting of: edible material base (FIG. 1) edible center piece (FIG. 2) edible retainer ring (FIG. 3) edible peddles (FIG. 4) adhering liquid (FIG. 5) peddle structure variations concave, convex, horizontal (FIG. 6).

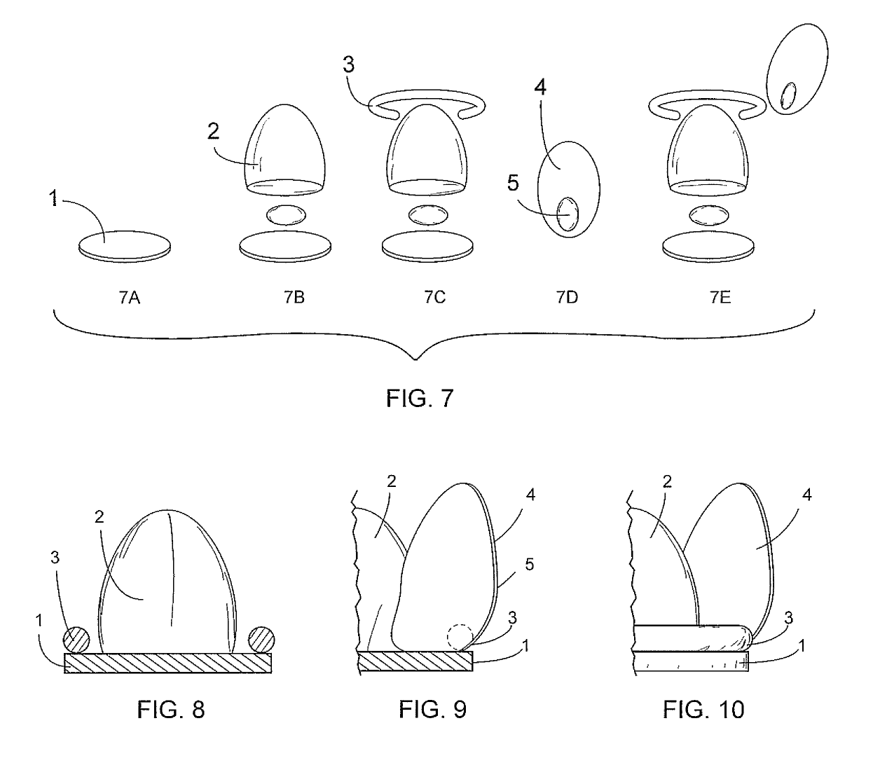

Referring to invention in (FIG. 7) the base (7A) is coated in some way with theobroma cacao chocolate in either consistency, sweetness or spiced. The center piece (FIG. 2) is coated with icing, meat glaze, gravies, edible confectionary material or colored as theme flora requires. The center piece (FIG. 2) once coated (as required) is affixed to base (FIG. 1) (FIG. 7B) with adhering liquid (FIG. 5) either with confectionary icing or theobroama cacao chocolate or gravy and or any edible substance feasible. Retainer ring (FIG. 3) is placed around the center piece (FIG. 2) (FIG. 7C) but not outside the base (FIG. 1) diameter.

Flora Peddles (FIG. 4) comprised of any suitable edible material are coated in some way in either consistency of theobroma cacao chocolate seasoned, unseasoned. On each flora peddle (FIG. 4) a small amount of adhering liquid (FIG. 5) (FIG. 7D) comprised of theobroma cacao chocolate or gravy, meat glaze placed at one end of the peddle (FIG. 4).

Once the adhering liquid (FIG. 5) is place on the intending floral peddle (FIG. 4) it (the peddle FIG. 4) is then wedged between the retainer ring (FIG. 3) and the center piece

(FIG. 2) (FIG. 7E).

(FIG. 16 complete flora replica, FIGS. 8 through 15 cross sections, various cross views)

### Possible Dimensions

Invention configuration dimensions flexible in size comprised of any circular, square, triangle, but not limited to the aforementioned requires the retention ring (FIG. 3) to also match the configuration dimension desired. The retention ring (FIG. 3) of required size to the over all sized of the invention application allows the required flora peddle to hold desired shape relative to the desired flora configuration theme. Equally the edible flora peddle has to match concave or convex or horizontal and or any combination needed to have the edible flora peddle connect to and hold shape with retention ring (FIG. 3) and edible center piece (FIG. 2) and edible base (FIG. 1) with assistance of attaching liquid (FIG. 5) also of required size to the over all sized of the invention.

### Advantages

Mixing edible material(s) of various compositions allow for the edible flora to be unsweetened, sweetened, spiced and seasoned and any variation of the previous edible material. Colored and arraying in flora themes which once arranged allows the flora replica to be enjoyed by any and all dietary restricted, consumer, cultural society, event and gathering restricting no one.

While the foregoing written description of the inventions enables one of ordinary skill to make and use what is considered presently to be the best mode thereof, those of ordinary skill will understand and appreciate the existence of variations, combinations, and equivalents of the specific embodiment, method, and examples herein. The invention should not be limited by the above described embodiment, method, and examples, but by all embodiments and methods within the scope and spirit of the invention.

### DRAWING REFERENCE NUMBERING

1. Base

2. Center Piece

3. Retainer Ring

4. Peddles

5. Attaching Liquid

6. Peddle structure variations concave, convex, horizontal

### FIG. 7 Best Method of Assembly

7A. Base

7B. Base, Attaching Liquid, Center Piece

7C. Base, Attaching Liquid, Center Piece, Retainer Ring

7D. Peddle, Attaching Liquid

7E. Base, Attaching Liquid, Center Piece, Retainer Ring, Attaching Liquid, Peddle

FIG. 8 Cross cut view showing assembled—base 1, center piece 2, retainer ring 3

FIG. 9 Cut view showing assembled—peddle 4 to base 1 and retainer ring 3 behind

FIG. 10 Cut view showing assembled—retainer ring 3 wrapped around peddle 4 on base 1

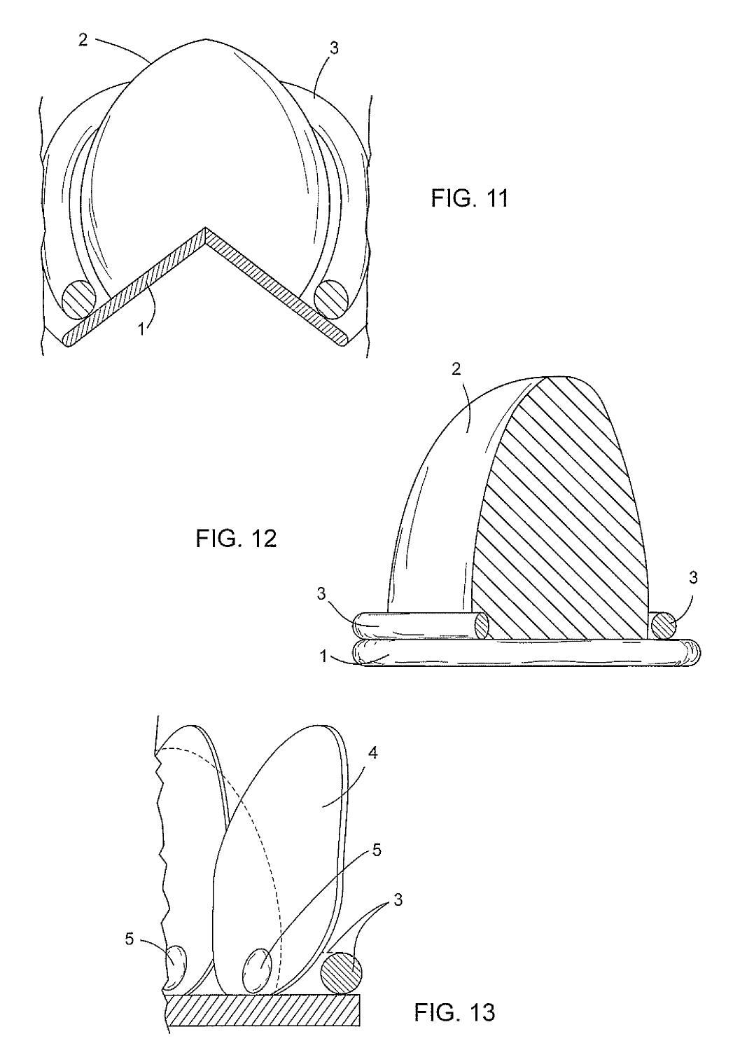

FIG. 11 Aerial cut view showing assembled—base 1, center piece 2, retainer ring 3 wrapped around center piece 2

FIG. 12 Side cut view showing assembled—base 1, center piece 2, retainer ring 3

FIG. 13 Side cut view showing assembled—peddle 4, attaching liquid 5 wedged between center piece 1 and retainer ring 3 on base 1

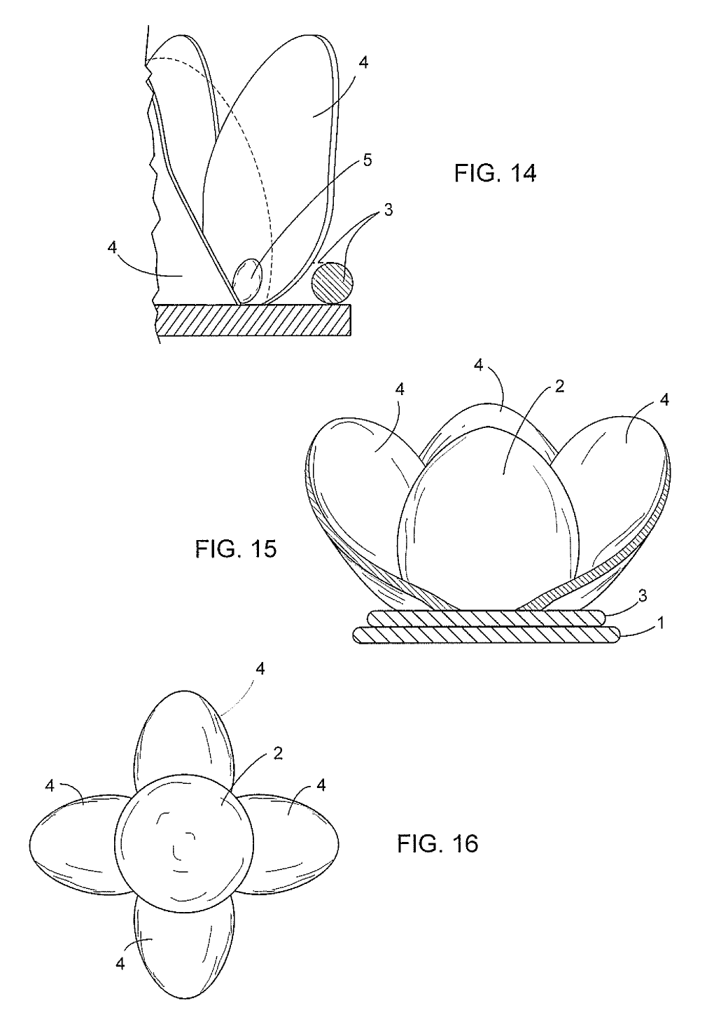

FIG. 14 Side cut view showing assembled—peddle 4 placements with attaching liquid 5 enclosed by retainer ring 3 and corresponding peddle placement

FIG. 15 Front cut view of assembled invention showing all invention elements nearly completing flora replica invention

FIG. 16 Aerial top view of complete assembled invention not showing the base and retainer ring hidden by peddle and center piece.

### BRIEF DESCRIPTION OF SEVERAL VIEWS OF THE DRAWINGS

FIG. 1 Edible Base of invention showing different shape configuration options of invention base that could be used to construct invention.

FIG. 2 Edible Center Piece showing different configuration options of invention center piece

FIG. 3 Edible Retainer Ring showing options of retainer ring conforming to shape of invention base FIG. 1.

FIG. 4 Edible Floral Peddles showing different shape configuration options of invention that could be used to construct invention.

FIG. 5 Edible Attaching Liquid showing the shape configuration options of invention that could be used to construct invention.

FIG. 6 Edible Floral Peddle curvature and non curvature options used to construct invention.

FIG. 7
7A. Base
7B. Base, Attaching Liquid, Center Piece
7C. Base, Attaching Liquid, Center Piece, Retainer Ring
7D. Peddle, Attaching Liquid
7E. Base, Attaching Liquid, Center Piece, Retainer Ring, Attaching Liquid, Peddle

FIG. 8 Cross cut view showing assembled—base 1, center piece 2, retainer ring 3

FIG. 9 Cut view showing assembled—peddle 4 to base 1 and retainer ring 3 behind

FIG. 10 Cut view showing assembled—retainer ring 3 wrapped around peddle 4 on base 1

FIG. 11 Aerial cut view showing assembled—base 1, center piece 2, retainer ring 3 wrapped around center piece 2

FIG. 12 Side cut view showing assembled—base 1, center piece 2, retainer ring 3

FIG. 13 Side cut view showing assembled—peddle 4, attaching liquid 5 wedged between center piece 1 and retainer ring 3 on base 1

FIG. 14 Side cut view showing assembled—peddle 4 placements with attaching liquid 5 enclosed by retainer ring 3 and corresponding peddle placement

FIG. 15 Front cut view of assembled invention showing all invention elements nearly completing flora replica invention

FIG. 16 Aerial top view of complete assembled invention not showing the base and retainer ring hidden by peddle and center piece.

1. Assembly of chocolate coated edible material depicting floras replicas;
Comprised of:
A. Theobroma cacao chocolate in either liquid state or dehydrated either consistency comprised of sweetened, unsweetened, seasoned and or spiced and or any configuration of the aforementioned. The theobroma cacao chocolate in all its consistencies and varieties conjoins or coats whole or in part and in some way adheres or helps to adhere all the edible elements together,
B. A base comprised of any edible material of any size and shape consistent to the flora theme and size, coated in whole or in part with theobroma cacao chocolate as flora theme requires,
C. A center piece of any edible material of any size or shape consistent to the flora theme and size coated as required with theobroma cacao chocolate or any edible material and or color as required,
D. A retention ring comprised of any edible material that is suitable in size, shape, color consistent to the flora theme and suitable for its duty,
E. A flora peddle(s) comprised of any suitable edible material that is also suitable in size, shape, color, any peddle configuration, coated or coated in part with theobroma cacao chocolate sweetened, unsweetened, spiced or seasoned and or any combination their of,
F. Adhering liquid comprised of theobroma cacao chocolate sweetened or unsweetened spiced or seasoned and or any suitable edible material with ability to conjoin edible material together to aid in flora replica structure.

2. Assembly of chocolate coated edible material depicting floras replicas in claim 1 where in all pieces used for said flora replica are in some way purely chocolate coated and or in some form coated edible material with theobroma cacao chocolate in all it's varieties.

3. Claim 1B The said base of desired form and size.

4. The said base claim 1B along with said adhering liquid claim 1F attaches said center piece claim 1C to the said base claim 1B.

5. The retention ring claim 1D is placed on said base claim 1B and around said center piece claim 1C but not outside the diameter of said base claim 1B.

6. Adhering liquid claim 1F is placed on the said floral peddles claim 1E and said peddles claim 1E are wedged between said retention ring claim 1D and said center piece claim 1C resting on said base claim 1B,
Where by
Once assembled creates the aesthetic appearance of a flora assembled with same or contrasting texture(s) and flavor(s) sweet or unsweetened and or savory,
Overcoming issues other prior art had by exclusion of dietary restricted consumers.
